(19) United States
(12) Patent Application Publication
(10) Pub. No.: US 2023/0100803 A1
(43) Pub. Date: Mar. 30, 2023

(54) WINDSHIELD WITH LAMINATED DISPLAY REGION, DISPLAY DEVICE AND MOTOR VEHICLE HAVING WINDSHIELD OF THIS KIND

(71) Applicant: AUDI AG, Ingolstadt (DE)

(72) Inventors: Ulrich BEIERLEIN, Ingolstadt (DE); Philipp WEISS, Dusseldorf (DE)

(73) Assignee: AUDI AG, Ingolstadt (DE)

(21) Appl. No.: 17/910,115

(22) PCT Filed: Mar. 12, 2021
(86) PCT No.: PCT/EP2021/056409

§ 371 Date: Sep. 8, 2022

(30) Foreign Application Priority Data
Mar. 20, 2020 (DE) 10 2020 107 726.2

(51) Int. Cl. B60K 35/00; G02B 27/01

(52) U.S. Cl. CPC B60K 35/00; G02B 27/0101; B60K 2370/1529; B60K 2370/785; B60K 2370/66

(57) ABSTRACT

Described is a windshield for a vehicle, for example, a motor vehicle, having a peripheral edge region. The peripheral edge region may contain a black print. The windshield may have at least one separate dark display region, which is isolated from the black print in the edge region. The dark display region may be a film laminated in the windshield. Further described are a display device for such a windshield and a motor vehicle having such a windshield.

### CROSS-REFERENCE TO RELATED APPLICATIONS

This application is a U.S. national stage of International Application No. PCT/EP2021/056409, filed on Mar. 12, 2021. The International Application claims the priority benefit of German Application No. 10 2020 107 762.2 filed on Mar. 20, 2020. Both the International Application and the German Application are incorporated by reference herein in their entirety.

### FIELD

The present description relates to a windshield for a vehicle, in particular a motor vehicle, having a peripheral edge region, wherein the edge region contains a black print. Furthermore, the present description relates to a display device for a motor vehicle and to a motor vehicle.

### BACKGROUND

Various techniques are known for the display of items of information in the region of a window, in particular in the front window or windshield of a vehicle, such as curved organic light-emitting diode (OLED) displays, head-up displays, displays laminated in the window, transparent displays, and the like. Reference is made by way of example to documents DE 10 2008 048 778 A1, DE 10 2015 011 366 A1, and U.S. Pat. No. 2,011,073 773 A1.

Damage frequently occurs in vehicle windows, in particular the front windows or windshields, for example, due to rock strikes or the like. Accordingly, windshields are considered to be replaceable elements of a vehicle, which have to be replaced frequently. If electronic components are housed in such parts to be replaced frequently, such as the laminated displays mentioned, the replacement of a windshield is very costly. Furthermore, conductor tracks are visible in windshields having laminated displays if the displays are not arranged very close to peripheral regions of the windshield. It has been shown in the use of curved OLED displays, that curved OLED displays can be integrated, in particular laminated, into the windshield only with difficulty or not at all. Head-up displays typically require a relatively large amount of installation space and have the disadvantage that, for example, warning lights cannot be displayed in front of a dark background.

### SUMMARY

Described is a way of specifying a windshield in which the above disadvantages can be avoided in the display of items of information.

Described is a windshield for a vehicle, for example, a motor vehicle, that may have a peripheral edge region. The peripheral edge region may contain a black print. The windshield may have at least one separate dark display region, which is isolated from the black print in the edge region. The dark display region may be a film laminated in the windshield. Described may be a display device for a motor vehicle having such a windshield. The display device may have an optical component and a display region which may be separate from the optical component and on which projected items of information are displayable or displayed. The display region for the display device may be a dark, for example, a black, film laminated into a windshield of the motor vehicle. Described may be a motor vehicle having such a windshield and such a display device, the display device may have an optical component and a display region which may be separate from the optical component and on which projected items of information are displayable or displayed. The display region for the display device may be a dark, for example, a black, film laminated into a windshield of the motor vehicle. Advantageous examples having expedient refinements are described.

In an example, a windshield for a vehicle, for example, a motor vehicle, may have a peripheral edge region, wherein the peripheral edge region contains a black print. The windshield may have at least one separate dark display region, which is isolated from the black print in the peripheral edge region. The dark display region may be a film laminated in the windshield.

Such a dark display region can have an arbitrary shape. Therefore, such a dark display region in form of a dark film can be used flexibly at desired points of a windshield. The lamination of a dark film into a windshield may represent a cost-effective process. Furthermore, the windshield does not contain any costly electronic components, so that a replacement may possibly be cost-effectively.

In the windshield, the dark display region can be arranged at a distance from the black print. In this way, the dark display region may be perceived as a type of floating display. Furthermore, it is also made clear due to the separation from the black print that the dark display region may not be a part or a section of the black print, which may be arranged or embodied to be as inconspicuous as possible.

The dark display region can be formed like an island in that the dark display region may be surrounded by transparent sections of the windshield. For example, the dark display region can be surrounded on three sides by a transparent strip which may have a width of a few millimeters. The large transparent window surface can be arranged on a fourth side, for example, an upper side of the dark display region.

The dark display region can have a color which has the following values in the cyan, magenta, yellow, and key (black) (CMYK) color model:
C=0 to 100, M=0 to 90, Y=0 to 50, K=60 to 100.

In an example, the color of the dark display region may be represented by value combinations or values which may be perceived as black or anthracite gray or dark gray. The dark display region can thus be laminated as a black or anthracite-gray or dark-gray film into a window.

Further described is a display device for a motor vehicle, the display device may have an optical component, which may project items of information to be displayed, and may have a display region which may be separate from the optical component and on which the projected items of information are displayable or displayed. The display region may be a dark, for example, a black, film laminated into a windshield of the motor vehicle.

Also described is a motor vehicle having an above-described windshield and having an optical component which may project items of information to be displayed on a dark display region in the windshield.

In an example, in the motor vehicle, the dark display region can be provided above an interior trim element which may be arranged below the windshield. The interior trim element can have a recess here in such a way that the dark display region may be arranged at least partially in the recess. The interior trim element may be the one trim element on which a dashboard or/and a glove compartment or/and a center console of the motor vehicle may be provided.

The optical component can be arranged below the dark display region. In particular, the optical component can be accommodated in the trim element or can be arranged lowered in the trim element. The optical component can project a display of information upward to the dark display region provided in the windshield. From there, the display may be reflected or mirrored so that the information can be read off by a vehicle occupant, for example, a driver or/and a front passenger, from the dark display region.

### BRIEF DESCRIPTION OF THE DRAWINGS

These and other aspects and advantages will become more apparent and more readily appreciated from the following description of the examples of an invention, taken in conjunction with the accompanying drawings of which:

FIG. 1 shows a simplified and schematic view of a windshield outward from an interior;

FIG. 2 shows a simplified and schematic enlargement of the display region shown in FIG. 1;

FIG. 3 shows a simplified and schematic sectional illustration approximately corresponding to the section line III-Ill of FIG. 4;

FIG. 4 shows a simplified and schematic top view of a motor vehicle.

### DETAILED DESCRIPTION

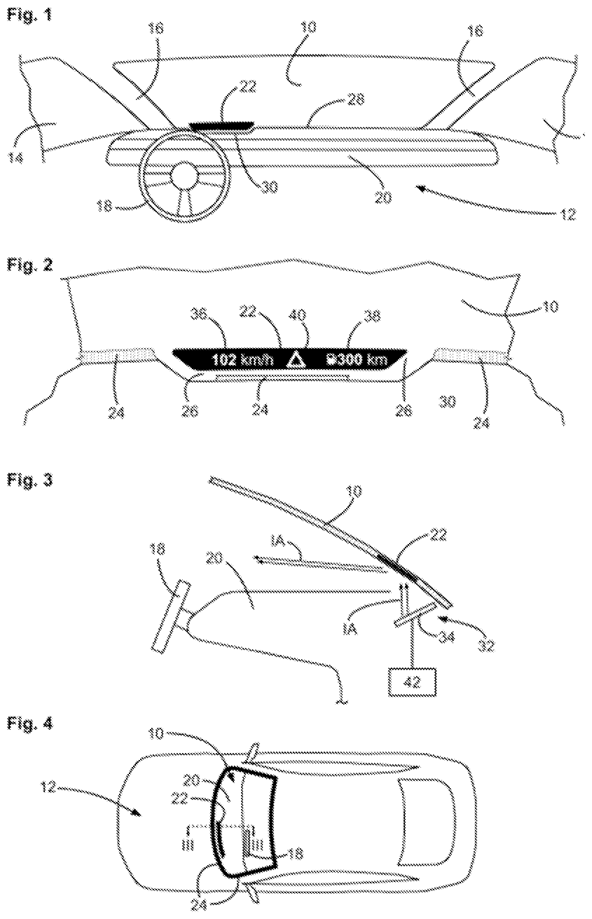

FIG. 1 shows a simplified and schematic illustration of a front window or windshield 10 of a motor vehicle 12, which may otherwise be only partially shown. The motor vehicle 12 is represented by way of example by indicated side windows 14 and front body struts (A pillars) 16. Furthermore, a steering wheel 18 is shown. A trim element 20 of the motor vehicle 12 is shown below the windshield 10.

A dark display region 22, shown pure black here by way of example, may be arranged in the windshield 10. The display region 22 may form a type of dark island within the otherwise transparent windshield 10. Items of information, for example, vehicle-relevant data, can be displayed on the display region 22. The display region 22 may be used here for mirroring or reflecting display elements which may be projected by an optical component (not visible in FIG. 1) onto the display region 22. The display region 22 may thus not be an active display having display elements, such as light-emitting diodes or the like, but rather a passive playback surface which may be provided in the region of the windshield 10.

FIG. 2 shows the display region 22 in an enlarged illustration. The display region 22 may be formed trapezoidal having rounded corners in this example. The display region 22 can have its greatest extension here in the width direction X of the windshield 10. However, the display region 22 can have any arbitrary shape, thus can be made, for example, rectangular or polygonal or ellipsoidal or the like. It is also conceivable that the display region 22 may be arranged along a lateral edge of the windshield in such a way that he display region 22 may have its greatest extension in the longitudinal direction along the windshield 10. Furthermore, the display region 22 can also be formed as a type of angle having a leg which extends in the width direction and a leg which extends in the longitudinal direction.

The windshield 10 may have a black print 24 along its peripheral edge region, which is illustrated vertically shaded in FIG. 2. The display region 22 may be provided separated or isolated from the black print 24. The display region 22 may accordingly be surrounded by a transparent window section 26. In this way, the display section 22 may appear like an island within the windshield 10. With respect to a visible upper edge 28 of the inner trim element 20, it may also be possible to say that the display region 22 is perceptible as floating in the windshield 10.

In the example shown in FIGS. 1 and 2, the trim element 20 has a recess 30. The recess 30 has a shaping complementary to the shape of the display region 22. In this way, the display region 22 can be arranged somewhat lower, so that a larger transparent window surface remains above the display region 22 and the field of view of the driver is not strongly impaired. The provision of a recess 30 is an option, however, which necessarily has to be provided.

FIG. 3 shows a simplified and schematic sectional illustration, which approximately corresponds to a section line III-Ill of FIG. 4, of a display device 32 which may have a display region 22 and an optical component 34. The optical component 34 may emit or project information in the direction of the display region 22. The display region 22 may reflect or mirror the information displayed by the optical component, so that the information can be read off for a vehicle occupant, for example, a driver of the motor vehicle 12, from the display region 22. In FIG. 3, the beam path of the displayed information may be identified in greatly simplified form by the arrows IA.

The display region 22 is formed as a dark or black film. The film is laminated into the windshield 10, which is illustrated in the sectional view of FIG. 3. FIG. 3 does not reproduce to scale the size relationships, in particular thicknesses, of windshield 10 and display region or film 22.

The information projected by the optical component 34 on the display region 22 can represent various vehicle-relevant parameters. In FIG. 2, a speed display 37, a range display 38, and a warning symbol 40 as representative of different warning signals that can be output or displayed are shown by way of example. The items of information 36, 38, 40 shown in FIG. 2 are solely by way of example and other items of information can also be displayed. For example, short scrolling texts could also be shown on the display region 22, which inform about traffic disruptions or the like.

The optical component 34 may be connected to a vehicle control unit 42, which is only schematically illustrated in FIG. 3. The vehicle control unit may activate the optical component 34 so that the desired information may be projected and displayed on the display region 22.

FIG. 4 shows a motor vehicle 12 in a top view in simplified and schematic form. In this illustration, the black print 24 is apparent, which may be provided peripherally on the windshield 10. Furthermore, a display region 22 is also shown in simplified form, which may be arranged as a dark or black film in the windshield 10. Furthermore, the interior trim element 20 and the steering wheel 18 are apparent.

Described is a windshield having a passive, for example, reflective or mirroring display region 22, which may enable a cost-effective replacement of the windshield 10. The windshield 10 can be replaced without any electronic components having to be disposed of together with the windshield 10.

A description has been provided with particular reference to examples, but it will be understood that variations and modifications can be effected within the spirit and scope of the claims, which may include the phrase “at least one of A, B and C” as an alternative expression that refers to one or more of A, B or C, contrary to the holding in Superguide v. DIRECTV, 358 F3d 870, 69 USPQ2d 1865 (Fed. Cir. 2004).

1-9. (canceled)

10. A windshield of a vehicle, the windshield comprising:
a black print to form a peripheral edge region of the windshield; and
at least one dark display region isolated from the black print in the peripheral edge region, the at least one dark display region is a film laminated in the windshield.

11. The windshield as claimed in claim 10, wherein the at least one dark display region is isolated by being arranged at a distance from the black print.

12. The windshield as claimed in claim 10, wherein the at least one dark display region is isolated by being formed like an island surrounded by transparent sections of the windshield.

13. The windshield as claimed in claim 10, wherein the at least one dark display region has a color which has values in a cyan, magenta, yellow and key (CMYK) color model as follows:
C=0 to 100, M=0 to 90, Y=0 to 50, K=60 to 100.

14. A display device for a motor vehicle, the display device comprising:
an optical component to project items of information to be displayed;
a display region, which is separate from the optical component and on which the projected items of information are displayable or displayed,
the display region is a dark film laminated in a windshield of the motor vehicle.

15. The display device as claimed in claim 14, wherein the display region is arranged at a distance from the black print.

16. The display device as claimed in claim 14, wherein the display region is formed like an island surrounded by transparent sections of the windshield.

17. The display region as claimed in claim 14, wherein the display region has a color which has values in a cyan, magenta, yellow and key (CMYK) color model as follows:
C=0 to 100, M=0 to 90, Y=0 to 50, K=60 to 100.

18. A motor vehicle, comprising:
a windshield having a peripheral edge region in form of a black print, the windshield having at least one dark display region isolated from the black print in the peripheral edge region, the at least one dark display region is a film laminated in the windshield, and
an optical component to project items of information to be displayed on the at least one dark display region in the windshield.

19. The motor vehicle as claimed in claim 18, wherein the display region is provided above an interior trim element, which is arranged below the windshield.

20. The motor vehicle (12) as claimed in claim 19, wherein the interior trim element has a recess in such a way that the display region is at least partially arranged in the recess.

21. The motor vehicle as claimed in claim 18, wherein the optical component is below the display region.

22. The motor vehicle as claimed in claim 18, wherein the at least one dark display region is isolated by being arranged at a distance from the black print.

23. The motor vehicle as claimed in claim 18, wherein the at least one dark display region is isolated by being formed like an island surrounded by transparent sections of the windshield.

24. The motor vehicle as claimed in claim 18, wherein the at least one dark display region has a color which has values in a cyan, magenta, yellow and key (CMYK) color model as follows:
C=0 to 100, M=0 to 90, Y=0 to 50, K=60 to 100.
